(19) United States
(12) Patent Application Publication
(10) Pub. No.: US 2009/0068409 A1
(43) Pub. Date: Mar. 12, 2009

(54) Skin cleansing and/or care article having a raised pattern at its surface and method of manufacturing said article

(75) Inventors: Bruno Bret, Wintzenheim (FR); Anne-Gaelle Clermont, Colmar (FR); Philippe Gregoire, Les Andelys (FR); Bernard Louis Dit Picard, Amfreville La Campagne (FR)

Correspondence Address: PATENT GROUP GA030-43;GEORGIA-PACIFIC LLC, 133 PEACHTREE STREET, N.E., ATLANTA, GA, 30303-1847, US

(73) Assignee: Georgia-Pacific France, Kunheim (FR)

(21) Appl. No.: 12/228,875

(22) Filed: Aug. 15, 2008

(30) Foreign Application Priority Data
Aug. 17, 2007 (FR) 07 05878

(51) Int. Cl. B32B 3/30; B32B 3/26; B32B 37/14

(52) U.S. Cl. 428/166; 428/172; 156/148

(57) ABSTRACT

The invention relates to a skin cleansing and/or care article, such as a makeup remover pad based on hydrophilic cotton fibres, intended to apply and/or remove liquid or semi-solid substances to/from the skin, comprising at least two outer layers (10a, 10b) made of an absorbent fibrous material that are joined together and at least one series of yarns (10d) placed between said outer layers (10a, 10b), the thickness of at least one of the outer layers (10b) being less than the average diameter of the yarns so as to create a raised pattern at the surface of the article.

Thus configured, the invention is capable of providing a skin cleansing and/or care article having a raised pattern at its surface which is formed not by compression of laps of fibres, but by the presence, under the outer layers of the article, of a series of yarns having a large diameter.

This application claims priority to copending French patent application number 07 05878, filed Aug. 17, 2007, the disclosure of which is incorporated herein by reference.

The invention relates to a skin cleansing and/or care article, such as a makeup remover pad based on hydrophilic cotton fibres, intended to apply and/or remove liquid or semi-solid substances to/from the skin.

Most of the skin cleansing and/or care articles present on the market are in the form of round, oval or square cut-out shapes. They are often composed of a mixture of cotton fibres of various qualities or a mixture of cotton fibres and other fibres depending on the absorption or strength properties desired. Nevertheless, it can also be envisaged to use non-woven materials formed solely from synthetic or artificial fibres.

Whatever the type of fibres used, it is observed that the commercial cleansing and/or care articles have a substantially homogeneous composition throughout their entire thickness. This results in a relative symmetry between each of the outer faces of said articles.

As is described in International Patent Application WO 01/42548 filed in the name of the Applicant, this lack of differentiation between the two outer faces of the article does not enable them to take on, beforehand, a particular function or use in the skin cleansing and care operation. In the aforementioned Patent Application, on the other hand, it is envisaged to form a cotton makeup remover pad having two separate faces, one intended for skincare, in particular for skin cleansing and for the application of makeup or makeup remover cosmetic products, and the other softer and more absorbent face intended for absorbing the excess products applied.

Since the differentiation is mainly made by the presence of recess patterns of the grooved type on one of the outer faces of the pad, the user is able to distinguish the faces either by feel, or visually.

In this prior art, it has also been observed that the presence of a relief, especially of groove type, favours the makeup removing efficiency.

Taking advantage of the latter observation, the Applicant has sought to further intensify the relief present at the surface of said pads.

In particular, the Applicant has sought to obtain makeup remover pads, and more generally skin cleansing and/or care articles, having a pronounced relief, especially in the wet state.

This is because, to date, the relief formed at the surface of the pads generally results from compression of the fibres either under the effect of embossing or calendering, or under the effect of a hydroentanglement process intended to join several laps of fibres together.

The drawback in these methods for relief formation is the difficulty in obtaining recesses or reliefs of large amplitude. Obtaining such reliefs is especially accompanied by an increased risk of perforation or tearing of the lap of fibres thus deformed and, therefore, leads to weakening of the pad in the end, which is not acceptable within the context of the envisaged cosmetic use.

Furthermore, once wetted, the relief often loses its amplitude, the fibres of the pad having a tendency to return to their initial position in the lap.

The invention therefore aims to provide a skin cleansing and/or care article that does not have the drawbacks of the prior art.

In particular, it aims to provide a skin cleansing and/or care article having a pronounced relief, even in the wet state, over at least one of its outer faces, the article furthermore having good strength and good cohesion so as to avoid any risk of tearing or perforation during its use.

Provided for this purpose, and according to the invention, is a skin cleansing and/or care article, such as a makeup remover pad based on hydrophilic cotton fibres, intended to apply and/or remove liquid or semi-solid substances to/from the skin, comprising at least two outer layers made of an absorbent fibrous material that are joined together and at least one series of yarns placed between said outer layers, the thickness of at least one of the outer layers being less than the average diameter of the yarns so as to create a raised pattern at the surface of the article.

According to one particular configuration of the invention, bonding of the outer layers is carried out by means of a technique chosen from hydroentanglement, glueing and hot-melt bonding.

According to one particular configuration of the invention, the article comprises two series of yarns placed between the outer layers, the yarns of each of the series being substantially parallel to one another and forming an angle α with the yarns of the other series.

According to another particular configuration of the invention, the two series of yarns are firmly attached within a single woven grid.

According to another particular configuration of the invention, the angle α is approximately equal to 90°.

According to another particular configuration of the invention, the raised pattern has protrusions of height H between 0.2 and 2.0 mm, and preferably between 0.3 and 0.5 mm.

The invention also relates to a skin cleansing and/or care article, such as a makeup remover pad based on hydrophilic cotton fibres, intended to apply and/or remove liquid or semi-solid substances to/from the skin, comprising at least two outer layers (10a, 10b) made of an absorbent fibrous material that are joined together and at least one series of yarns (10c, 10d, 10e, 10f) placed between said outer layers (10a, 10b), characterized in that the said series of yarns creates a raised pattern at the surface of the article, the said pattern having protrusions (5) of a height H and in that the ratio Rh of the height H of the protrusions (5) of the raised pattern when the article is wet to the height H of the protrusions (5) of the raised pattern when the article is dry is greater than 0.7, and preferably greater than 1.

According to another particular configuration of the invention, the raised pattern defines a plurality of cavities intended to receive the cleansing and/or care product.

According to another particular configuration of the invention, the article has a tensile strength in the dry state of at least 35 N in the machine direction and of at least 20 N in the cross direction, and preferably greater than 50 N in the machine direction and in the cross direction, according to the test method given in the description.

According to another particular configuration of the invention, the article has an average friction coefficient in the dry state and in the wet state greater than 0.35 and, in particular, an average friction coefficient in the wet state greater than the average friction coefficient in the dry state.

Thus configured, the invention is capable of providing a skin cleansing and/or care article having a raised pattern at its surface which is formed not by compression of laps of fibres, but by the presence, under the outer layers of the article, of a series of yarns having a large diameter.

The term “yarns” is understood to mean any solid filamentous structure that is in an elongate form. This therefore encompasses yarns obtained by a spinning process or an extrusion process and formed from a natural material, such as cotton, silk or linen or from an artificial material, such as viscose, or from a synthetic material, such as polypropylene, or from a mineral material, such as glass, or from a metallic material, such as steel or aluminium.

This also encompasses the elongate filamentous parts of certain two-dimensional structures, such as extruded or moulded grids or textile screens such as fabric.

The deformation of the outer layer or layers will be even greater when the diameter of the yarns is large. Moreover, this deformation will also depend on the number of yarns present under the outer layer or layers and on their arrangement with respect to one another. Thus, two superposed yarns will produce a deformation that is two times larger.

This raised pattern will also be much more stable during wetting of the article, given that no reorganization of the fibres of the lap will be able to take place in the regions covering the yarn.

Furthermore, due to the stiffness of the yarns used, the strength and cohesion of the article will also be improved.

Another subject of the invention is a method of manufacturing a skin cleansing and/or care article, comprising the following steps:
formation of at least a first outer layer of said article from a lap of absorbent fibres;
formation of at least a second outer layer of said article from a lap of absorbent fibres;
insertion of at least a first series of yarns between said first and second outer layers; and
assembly of said outer layers and of said series of yarns.

According to one particular configuration of the invention, the assembly of the outer layers and of the series of yarns is carried out by means of a technique chosen from hydroentanglement, glueing and hot-melt bonding.

According to another particular configuration of the invention, a second series of yarns is inserted between the first and second outer layers, the yarns of each of the first and second series being substantially parallel to one another and forming an angle α with the yarns of the other series.

According to another particular configuration of the invention, the yarns of the first series are deposited after and on top of the yarns of the second series.

According to another particular configuration of the invention, the yarns of the second series are deposited so as to form, with the yarns of the first series, a structure similar to a textile screen, the yarns of the first series forming the warp yarns and the yarns of the second series forming the weft yarns.

According to another particular configuration of the invention, the angle α is approximately equal to 90°.

According to another particular configuration of the invention, the laps of fibres are mainly formed from hydrophilic cotton fibres.

According to another particular configuration of the invention, the laps of fibres comprise from 70 to 100% of cotton fibres and from 0 to 30% of artificial fibres, chosen especially from viscose fibres, synthetic fibres, such as polyester fibres, two-component fibres of the polyester/polyester, polypropylene/polypropylene or polyester/polypropylene type, or mixtures thereof.

According to another particular configuration of the invention, the yarns are manufactured from a material chosen from polymers of natural, artificial or synthetic origin, metallic materials and mineral materials.

According to another particular configuration of the invention, the yarns are formed according to a method chosen from spinning, extrusion and moulding.

The invention also targets a skin cleansing and/or care article, such as a makeup remover pad based on hydrophilic cotton fibres, intended to apply and/or remove liquid or semi-solid substances to/from the skin, comprising at least a first outer layer made of an absorbent fibrous material and at least a second outer layer comprising a series of yarns, said yarns forming a raised pattern at the surface of the article.

Other features and advantages of the invention will appear in more detail in the description which follows and with reference to the appended drawings in which:

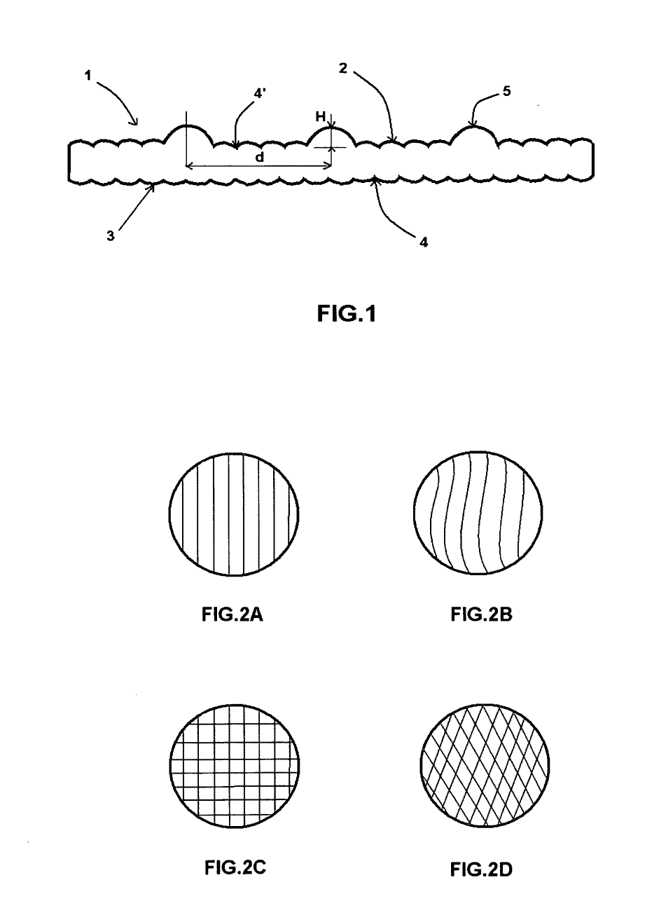

FIG. 1 represents a side view of a cleansing and/or care article according to the invention.

FIGS. 2A, 2B, 2C and 2D represent various raised patterns which may be applied to an article according to the invention.

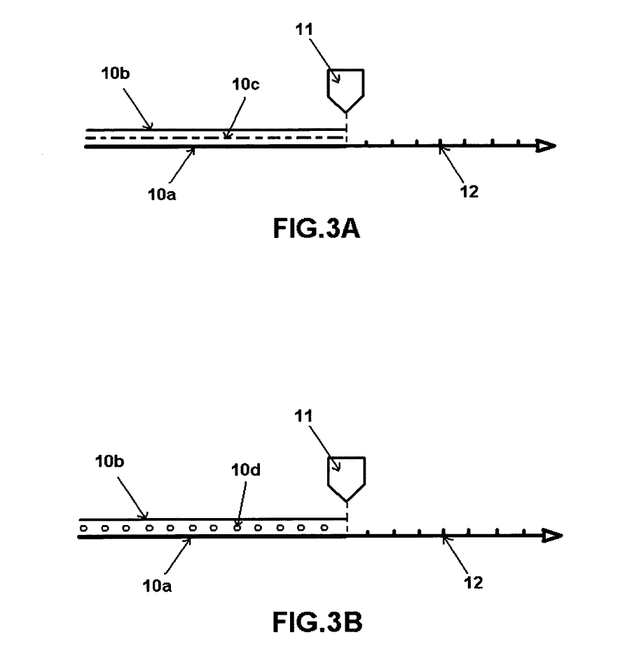

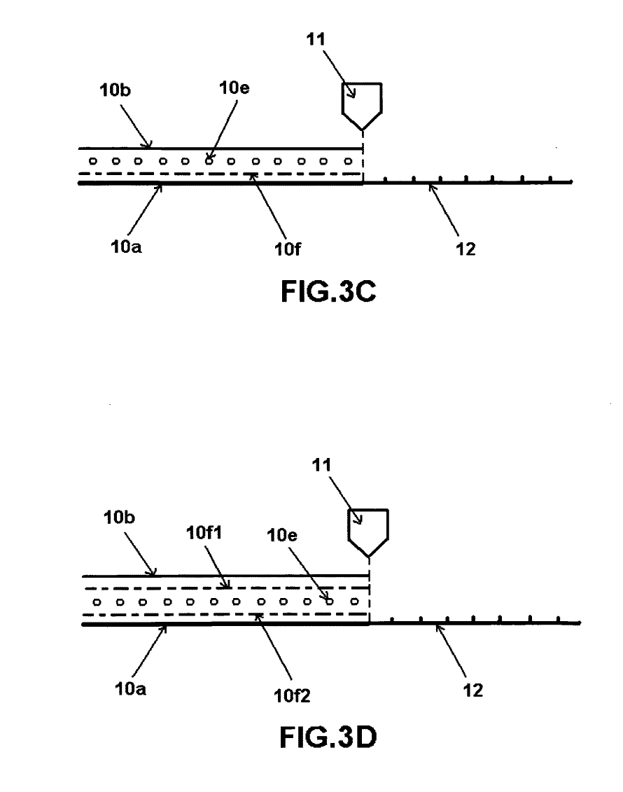

FIGS. 3A, 3B, 3C and 3D represent various modes of manufacturing an article according to the invention.

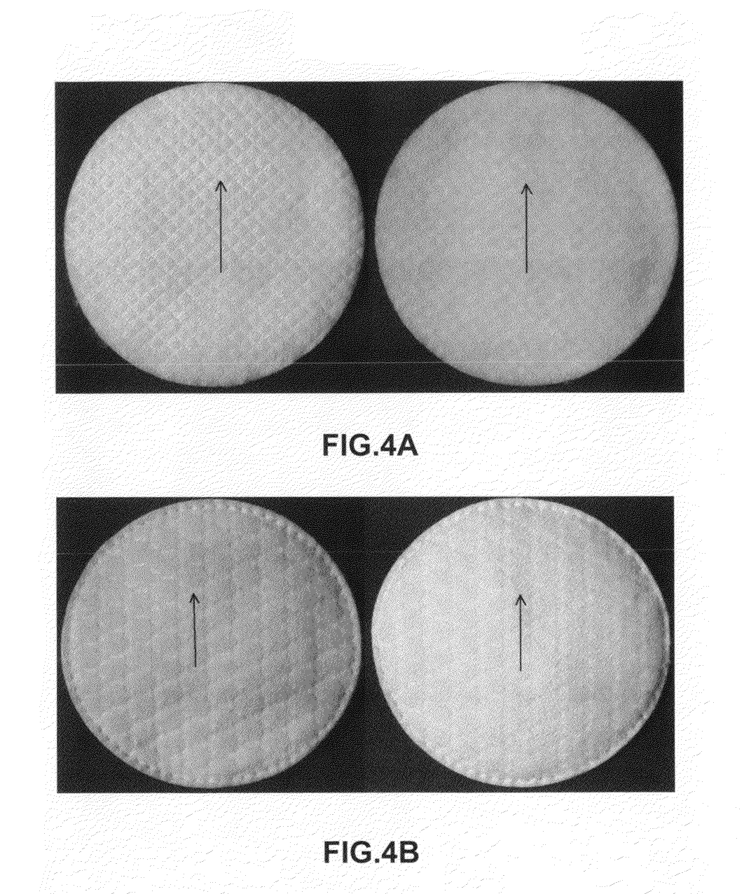

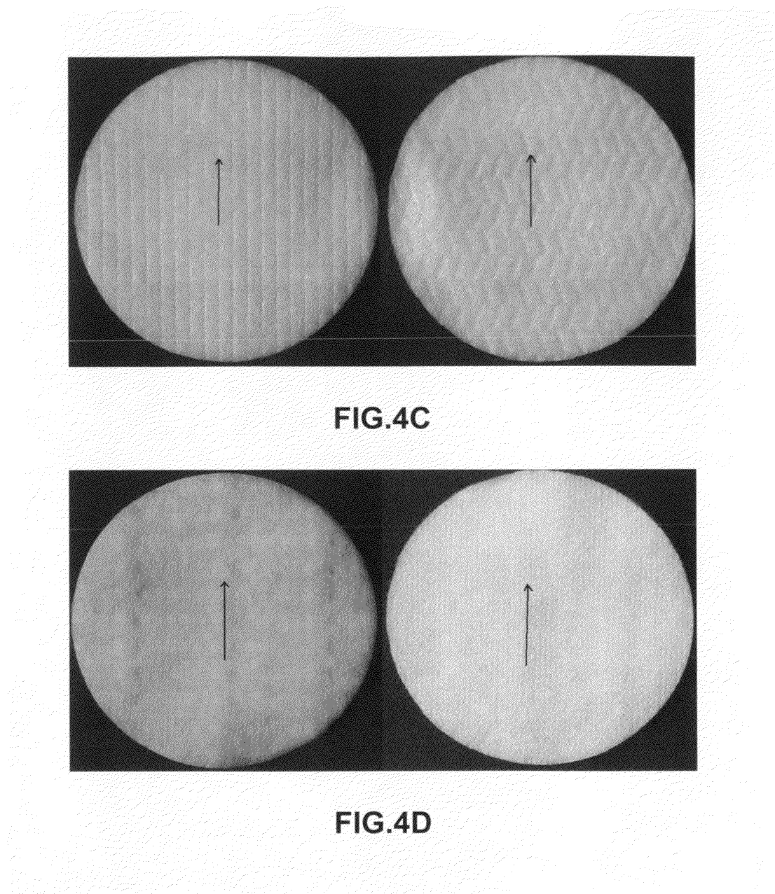

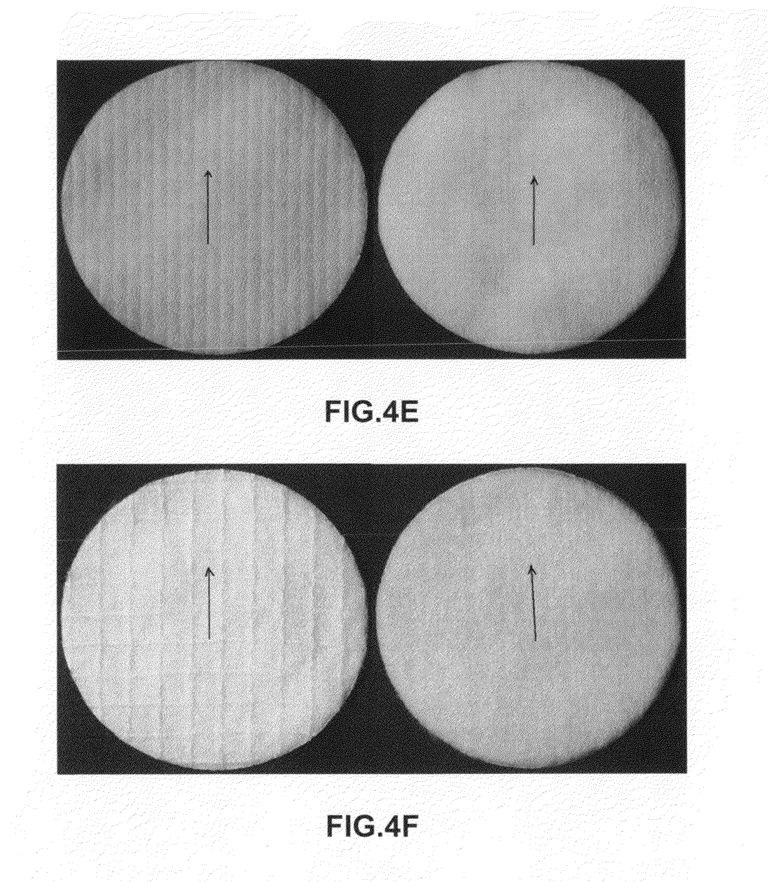

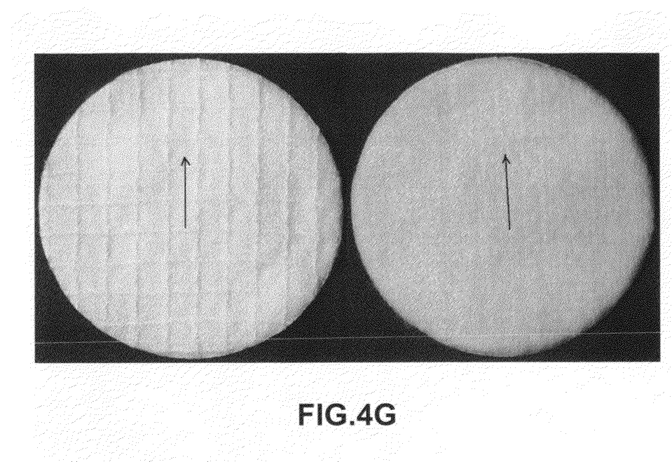

FIGS. 4A, 4B, 4C, 4D, 4E, 4F and 4G are photographs of the obverse and reverse faces of makeup remover pads cited in the examples.

A skin cleansing and/or care article according to the invention is generally a cut-out product of round, oval or square shape or of any other shape. It has a basis weight between 80 and 400 g/m² and preferably between 100 and 300 g/m². It may be formed from absorbent hydrophilic cotton fibres. In particular, it may comprise from 70 to 100 percent of homogeneous quality fibres and from 0 to 30 percent of artificial fibres such as viscose fibres, and/or of synthetic fibres such as polyester fibres, two-component fibres (polyester/polyester, polypropylene/polypropylene or polyester/polypropylene), or mixtures thereof. It can of course be envisaged to use any other type of natural, synthetic or artificial fibres and in different proportions to manufacture said article: the choice of the type of fibres and the proportions will be made in this case so as to give the article the desired absorption and softness properties at the end.

In all the examples which follow, the article will be formed from one and the same base support, namely a single-layer or multilayer thick lap formed from cotton fibres, deposited on which is a thin lap, of the web type, also formed from cotton fibres, the assembly being hydro entangled so as to bond the laps together. The thick lap will, for example, have a basis weight between 100 and 250 g/m² and the thin lap will have a basis weight between 10 and 80 g/m².

Before the hydroentanglement step, one or more series of yarns will have first been inserted. These yarns will have a diameter greater than the thickness of the thin lap so as to deform it sufficiently and thus create a raised pattern at the surface of the article. It can of course be envisaged to accentuate this raised pattern by superposing one or more series of yarns. The thickness of the thin lap will in this case have to be less than the sum of the diameters of each of the superposed yarns. The diameter of the yarns could especially be between 200 and 2000 microns, and preferably between 300 and 800 microns. The yarns could be formed from a natural, artificial or synthetic polymer or from a mineral or metallic material. Preferably, in order to form the yarns, a material that swells in the presence of moisture, such as cotton, will be used so as to create a relief that can vary depending on the moisture conditions of the article, in particular a relief that is more accentuated when the article is wet (that is to say when it contains more than 100 wt % of water). This swelling will be variable as a function of the degree of twist of the yarn. This is because the more the yarn is twisted on itself, the lower its tendency to swell under the effects of moisture.

With reference to FIG. 1, a schematic side view of a skin cleansing and/or care article according to the invention is represented.

The article, or pad 1, comprises a first outer face 2 and a second outer face 3. The first and second outer faces 2 and 3 have grooves 4 and 4′ arranged parallel to one another. The grooves are formed by water jets exiting the nozzles of the hydroentanglement device, the power of the water jets and the gap between them determining the depth of the grooves 4 and 4′ and the gap between them respectively. Thus, the gap between the grooves 4 and 4′ could be between 0.4 and 1.2 mm and the depth of the grooves 4 could be less than 0.25 mm, and in particular of the order of 0.1 mm.

The pad 1 furthermore has a series of protrusions 5, that are substantially semi-cylindrical, over its outer surface 2. As seen previously, these protrusions 5 are formed on the regions of the thin lap of cotton fibres covering the stiff textile yarns. These protrusions could have a height H between 0.2 mm and 2.0 mm, and preferably between 0.3 mm and 0.5 mm. The distance d separating each of the protrusions 5 could vary as a function of the raised pattern to be formed and as a function of the region of the pattern observed. Out of concern for the makeup removing efficiency, raised patterns are however favoured for which the distance d between each protrusion 5 is substantially equal over the entire width of the pad 1 and is between 2 and 15 mm and preferably between 5 and 12 mm. It can however be envisaged to vary this distance d over certain regions of the raised pattern so as to create rougher or smoother regions on the pad 1 and thus to locally modify the makeup removing efficiency of said pad 1.

With reference to FIGS. 2A to 2D, several examples of raised patterns formed at the surface of a cleansing and/or care article according to the invention are represented. Thus, the protrusions could form, at the surface of the article, continuous straight lines (FIG. 1, FIG. 2A) or continuous curved lines (FIG. 2B). They could also form a square-mesh grid (FIG. 2C) or a lozenge-shaped grid (FIG. 2D).

Furthermore, so as to facilitate the application of cosmetic products to the article and consequently the transfer of these products to the skin, it will be advantageous to form receiving cavities at the surface of the article. These receiving cavities will be delimited by the protrusions of the raised pattern. Thus, in FIG. 2C, or 2D respectively, each square, or lozenge respectively, of the raised pattern could potentially form a receiving cavity for the cleansing and/or care products.

With reference to FIGS. 3A to 3D, different variants for producing the article according to the invention are represented.

Whichever variant is envisaged, the same base support for the article is always produced, such as defined previously, by producing, on the one hand, a thick fibrous lap 10a, having a basis weight between 100 and 250 g/m² and, on the other hand, a thin fibrous lap 10b having a basis weight between 10 and 80 g/m². The superposition of the two laps is then hydro entangled by means of a hydroentanglement device 11. The method for forming such a base support has in particular been described in detail in European Patent EP 0 681 621 filed in the name of the Applicant.

Prior to the hydroentanglement step, and as a function of the envisaged variant, it will be possible to insert between the thick lap and the thin lap either a woven scrim 10c that has already been formed (FIG. 3A), or a series of textile yarns 10d that are parallel to one another (FIG. 3B), or a first series of textile yarns 10e that are parallel to one another and a second series of textile yarns 10f that are parallel to one another, the yarns 10e of the first series being superposed and substantially orthogonal to the yarns 10f of the second series (FIG. 3C), or a first series of textile yarns 10e that are parallel to one another and a second series of textile yarns 10f1 and 10f2 that are parallel to one another, each yarn 10e of the first series being alternately arranged underneath a yarn 10f1 and on top of a yarn 10f2 of the second series, in the manner of a weft yarn held between the warp yarns of a textile material, the yarns 10e of the first series being substantially orthogonal to the yarns 10f1 and 10f2 of the second series (FIG. 3D).

The insertion of the yarns or of the woven scrim between the two laps of fibres 10a and 10b could be carried out, in particular, by means of a shuttle, a rapier, an air jet or a water jet, this list not being limiting.

Once the hydroentanglement of the assembly has been carried out, a bonded lap 12 is therefore obtained having a series of protrusions on at least one of its outer surfaces, which forms a raised pattern.

The bonded lap 12 is then cut into the shape of the articles to be obtained.

### Comparative Tests

A series of measurements on products according to the invention and on commercial products were carried out.

The products used for this purpose were respectively:

Product A: AUCHAN brand makeup remover pad formed by the assembly, by hot-melt bonding, of cotton fibres and of thermoplastic fibres, then formation of a relief by calendering on the obverse face (FIG. 4A).

Product B: SWISSPERS brand makeup remover pad obtained by formation of a relief by calendering on its obverse and reverse faces and assembly, by peripheral punching, of three cotton laps (FIG. 4B).

Product C: CORA brand makeup remover pad formed by the assembly, by a binder, of three cotton laps, the two outer laps having been calendered individually beforehand (FIG. 4C).

Product D: CHAMPION brand makeup remover pad formed by single hydroentanglement of a cotton lap on its obverse face, and double hydroentanglement on its reverse face (FIG. 4D).

Product E: DEMAK'UP brand makeup remover pad which conforms to the International Patent Application WO 01/42548 (FIG. 4E).

Product F: makeup remover pad according to the invention, having three series of cotton yarns inserted between two cotton laps, the yarns forming a grid type raised pattern at the surface of the pad, a large-diameter yarn, forming the warp yarn, being trapped between two small-diameter yarns, forming the weft yarn (FIG. 4F); the properties of the cotton yarns used were:
Diameter of the warp yarn (dry state)=560 μm;
Diameter of the weft yarn (dry state)=310 μm;
Diameter of the warp yarn (wet state)=670 μm; and
Diameter of the weft yarn (wet state)=390 μm.

Product G: makeup remover pad according to the invention (FIG. 4G) differing from the product F by the diameter of the yarns used:
Diameter of the warp yarn (dry state)=580 μm;
Diameter of the weft yarn (dry state)=330 μm;
Diameter of the warp yarn (wet state)=710 μm; and
Diameter of the weft yarn (wet state)=410 μm.

The measurements carried out on these products were respectively:
the basis weight W (in g/m²);
the thickness t (in mm);
the tensile strength TS (in N) in the dry state, in the machine direction and in the cross direction;
the height H of the protrusions (in microns) in the dry state and in the wet state, in the machine direction and in the cross direction; and
the friction coefficient FC in the dry state and in the wet state, in the machine direction and in the cross direction.

For the tests given above, the dry state of the product corresponded to the initial state of the unimpregnated product, and the wet state of the product corresponded to a state where the product had been impregnated with around 800 wt % of distilled water.

So as to make the distribution of the water in the product in the wet state uniform, a weight of 3540 g was placed on the product for 60 seconds just after it had been impregnated with the distilled water.

Moreover, indicated on FIGS. 4A to 4G by means of an arrow is the machine direction as it was measured on each of the products and on each of the faces.

The cross direction obviously corresponds to the direction which is orthogonal to the machine direction.

Each of the measurement methods used during these comparative tests is explained below.

### Measurement of the Thickness

A weight of 53.7 g was placed on a pile of 20 makeup remover pads.

The height of the pile thus compressed was measured.

The height measured was divided by 20.

The value thus calculated corresponds to the thickness t.

### Measurement of the Tensile Strength

Samples or test specimens having a length of 57 mm and a width of 25 mm were cut out of the pads to be tested. A first series of samples was cut so as to obtain the greatest length of the sample in the machine direction and so as to cover the reliefs of the surface. A second series of samples was cut so as to obtain the greatest length of the sample in the cross direction and so as to also cover the reliefs of the surface.

The measurement of the strength was carried out by means of a tensile testing machine.

The sample was placed between the two jaws of the tensile testing machine separated by a distance of 30 mm in the length direction of the sample. The jaws were separated at a rate of 100 mm/min and the maximum force exerted before breaking was measured.

This maximum force is the tensile strength TS.

### Measurement of the Height of the Protrusions

An unimpregnated makeup remover pad was placed under a digital video camera connected to a computer, the face of the pad having the raised pattern being turned towards the camera.

The data exported was analysed by means of software for analysing a three-dimensional shot by fringe projection and by means of TOPOSURF measurement software.

Both software make it possible to give a very precise surface topography of the regions observed.

A series was chosen of three homogeneous regions for measurement in the machine direction and in the cross direction, preferably on the zones of the pad comprising the highest protrusion heights.

The height H of the protrusions in these regions was measured. The average was taken of the three measurements carried out: the height H of the protrusions was obtained for one of the faces of the pad in the machine direction and in the cross direction.

Next, a series of similar measurements were carried out when the pad was in its wet state.

Next, the ratio Rh was calculated:

Rh=height H measured in the wet state/height H measured in the dry state.

### Measurement of the Friction Coefficient

A friction test machine supplied by Kato Tech. Co. Ltd. under the reference Friction Tester was used.

This machine functioned according to the KAWABATA method and provided at the end a coefficient FC, known as the friction coefficient of the sample.

The higher the coefficient FC, the rougher the tested face of the sample.

The samples to be tested were positioned so as to orient the faces provided with relief towards the measurement cell.

Thus, 4 measurements were carried out: in the machine direction and in the cross direction, in the dry state and in the wet state.

Next, the average friction coefficient (AFC) was calculated for the dry and wet sample:

AFC=(FCmd×FCcd)^{1/2},

with FCmd=friction coefficient in the machine direction; and

FCcd=friction coefficient in the cross direction.

The results are given in Tables 1 to 3.

TABLE 1

| | | | TS machine | TS cross |
|---|---|---|---|---|
| Product | W | t | direction | direction |
| A | 193 | 48 | 9 | 9 |
| B | 249 | 56 | 7 | 2 |
| C | 288 | 78 | 5 | 4 |
| D | 232 | 56 | 7 | 5 |
| E | 235 | 60 | 21 | 14 |
| F | 219 | 50 | 75 | 66 |
| G | 233 | 50 | 71 | 67 |

TABLE 2

| | H dry | H wet | Rh | H dry | H wet | Rh |
|---|---|---|---|---|---|---|
| Product | machine direction | machine direction | machine direction | cross direction | cross direction | cross direction |
| A | 286 | 284 | 0.99 | 279 | 277 | 0.99 |
| B | 470 | 284 | 0.60 | 455 | 243 | 0.53 |
| C line face | | | | 260 | 160 | 0.62 |
| C chevron face | 252 | 130 | 0.52 | 219 | 120 | 0.55 |
| D | 388 | 258 | 0.66 | 398 | 270 | 0.68 |
| E | | | | 230 | 150 | 0.65 |
| F | 300 | 424 | 1.41 | 353 | 220 | 0.62 |
| G | 273 | 405 | 1.48 | 335 | 257 | 0.77 |

TABLE 3

| | FC dry | FC dry | | FC wet | FC wet | |
|---|---|---|---|---|---|---|
| Product | machine direction | cross direction | AFC dry | machine direction | cross direction | AFC wet |
| A | 0.20 | 0.19 | 0.19 | 0.18 | 0.19 | 0.18 |
| B | 0.21 | 0.23 | 0.22 | 0.22 | 0.20 | 0.21 |
| C line face | 0.22 | 0.23 | 0.22 | 0.20 | 0.22 | 0.21 |
| C chevron face | 0.24 | 0.43 | 0.32 | 0.22 | 0.26 | 0.24 |
| D | 0.21 | 0.25 | 0.23 | 0.21 | 0.20 | 0.20 |
| E | 0.20 | 0.23 | 0.21 | 0.17 | 0.19 | 0.18 |
| F | 0.31 | 0.41 | 0.36 | 0.30 | 0.56 | 0.41 |
| G | 0.39 | 0.48 | 0.43 | 0.47 | 0.55 | 0.51 |

It is therefore observed that the pads according to the invention F and G have a tensile strength that is far greater than that of the commercial pads, and especially greater than 65 N.

It is also observed that the heights of the protrusions measured on the pads according to the invention are greater than the heights measured on the commercial pads in the machine direction and in the wet state.

Furthermore, it was surprisingly observed that this height increases in the wet state and in the machine direction for the pads according to the invention relative to that measured in the dry state (Rh>1).

This could be explained by the ability of the cotton yarns inserted between the laps of fibres to swell under the effect of moisture.

This ability to increase in volume, and therefore diameter, is however only observed for certain cotton yarns, given the results observed in the cross direction (Rh<1).

Without being tied to any one theory, it is probable that the more the cotton yarn is twisted, the lower its ability to increase in diameter in the wet state.

It is finally observed that the average friction coefficient AFC of the pads according to the invention is greater than that of the commercial pads, whether in the dry state or in the wet state.

In particular, it is observed that, for the pads according to the invention, the average friction coefficient (AFC) is greater than 0.35, whether in the dry state or the wet state, and the average friction coefficient in the wet state is greater than the average friction coefficient in the dry state.

The pads of the invention will therefore be rougher than the commercial pads and will therefore have an improved makeup removing efficiency, especially in the wet state.

What is claimed is:

1. A skin care pad (1) suitable for application of substances to the skin as well as removal of substances from the skin, said pad having at least one surface having a raised pattern defined thereupon, said skin care pad comprising: (a) at least two outer layers (10a, 10b) of absorbent fibrous material joined together; and (b) at least one series of yarns (10c, 10d, 10e, 10f) placed between said outer layers (10a, 10b), characterized in that the thickness of at least one of the outer layers (10b) is less than the average diameter of the yarns.

2. The skin care pad (1) according to claim 1, characterized in that the raised pattern has protrusions (5) of height H between 0.2 and 2.0 mm.

3. The skin care pad (1) according to claim 2, characterized in that the raised pattern has protrusions (5) of height H between 0.3 and 0.5 mm.

4. The skin care pad (1) according to claim 1, characterized in that the ratio Rh of the height H of the protrusions (5) of the raised pattern when the article is wet to the height H of the protrusions (5) of the raised pattern when the article is dry is greater than 0.7.

5. The skin care pad (1) according to claim 2, characterized in that the ratio Rh of the height H of the protrusions (5) of the raised pattern when the article is wet to the height H of the protrusions (5) of the raised pattern when the article is dry is greater than 1.

6. The skin care pad (1) according to claim 1, characterized in that the raised pattern defines a plurality of cavities.

7. The skin care pad (1) according to claim 1, characterized in that it has a tensile strength in the dry state of at least 35 N in the machine direction and of at least 20 N in the cross direction according to the test method given in the description.

8. The skin care pad (1) according to claim 1, characterized in that it has an average friction coefficient in the dry state and in the wet state greater than 0.35 and, an average friction coefficient in the wet state greater than the average friction coefficient in the dry state.

9. The skin care pad (1) according to claim 1, characterized in that it comprises two series of yarns (10e, 10f) placed between the outer layers (10a, 10b), the yarns of each of the series being substantially parallel to one another and forming an angle α with the yarns of the other series.

10. The skin care pad (1) according to claim 9, characterized in that the raised pattern has protrusions (5) of height H between 0.2 and 2.0 mm.

11. The skin care pad (1) according to claim 9, characterized in that the raised pattern has protrusions (5) of height H between 0.3 and 0.5 mm.

12. The skin care pad (1) according to claim 11 characterized in that the ratio Rh of the height H of the protrusions (5) of the raised pattern when the article is wet to the height H of the protrusions (5) of the raised pattern when the article is dry is greater than 0.7.

13. The skin care pad (1) according to claim 10 characterized in that the ratio Rh of the height H of the protrusions (5) of the raised pattern when the article is wet to the height H of the protrusions (5) of the raised pattern when the article is dry is greater than 1.

14. The skin care pad (1) according to claim 9 characterized in that the angle α is approximately equal to 90°.

15. The skin care pad (1) according to claim 14, characterized in that the raised pattern has protrusions (5) of height H between 0.2 and 2.0 mm.

16. The skin care pad (1) according to claim 14, characterized in that the raised pattern has protrusions (5) of height H between 0.3 and 0.5 mm.

17. The skin care pad (1) according to claim 14, characterized in that the ratio Rh of the height H of the protrusions (5) of the raised pattern when the article is wet to the height H of the protrusions (5) of the raised pattern when the article is dry is greater than 0.7.

18. The skin care pad (1) according to claim 15, characterized in that the ratio Rh of the height H of the protrusions (5) of the raised pattern when the article is wet to the height H of the protrusions (5) of the raised pattern when the article is dry is greater than 1.

19. The skin care pad (1) according to claim 14, characterized in that the two series of yarns are firmly attached within a single woven grid (10c).

20. The skin care pad (1) according to claim 19, characterized in that the raised pattern has protrusions (5) of height H between 0.2 and 2.0 mm.

21. The skin care pad (1) according to claim 19, characterized in that the raised pattern has protrusions (5) of height H between 0.3 and 0.5 mm.

22. The skin care pad (1) according to claim 19, characterized in that the ratio Rh of the height H of the protrusions (5) of the raised pattern when the article is wet to the height H of the protrusions (5) of the raised pattern when the article is dry is greater than 0.7.

23. The skin care pad (1) according to claim 20, characterized in that the ratio Rh of the height H of the protrusions (5) of the raised pattern when the article is wet to the height H of the protrusions (5) of the raised pattern when the article is dry is greater than 1.

24. A skin care pad (1) suitable for application of substances to the skin as well as removal of substances from the skin, said pad having at least one surface having a raised pattern defined thereupon, said skin care pad comprising: (a) at least two outer layers (10a, 10b) made of an absorbent fibrous material that are joined together; and (b) at least one series of yarns (10c, 10d, 10e, 10f) placed between said outer layers (10a, 10b), characterized in that the series of yarns creates a raised pattern at the surface of the article, said pattern having protrusion (5) of a height H and in that the ratio Rh of the height H of the protrusions (5) of the raised pattern when the article is wet to the height H of the protrusions (5) of the raised pattern when the article is dry is greater than 0.7.

25. The skin care pad (1) according to claim 16, characterized in that the raised pattern defines a plurality of cavities intended to receive the cleansing and/or care product.

26. The skin care pad (1) according to claim 16, characterized in that it has a tensile strength in the dry state of at least 35 N in the machine direction and of at least 20 N in the cross direction, according to the test method given in the description.

27. The skin care pad (1) according to claim 16, characterized in that it has an average friction coefficient in the dry state and in the wet state greater than 0.35 and, an average friction coefficient in the wet state greater than the average friction coefficient in the dry state.

28. A method of manufacturing a skin care pad (1), comprising the following steps:
a) forming at least a first outer layer (10a) of said pad (1) from a lap of absorbent fibres;
b) formation of at least a second outer layer (10b) of said pad (1) from a lap of absorbent fibres;
c) placement of at least a first series of yarns (10c, 10d, 10e) between said first (10a) and second (10b) outer layers; and
d) joining said outer layers (10a, 10b) and said series of yarns (10c, 10d, 10e).

29. The method according to claim 28, characterized in that joining of the outer layers (10a, 10b) and of the series of yarns (10c, 10d, 10e, 10f) is carried out by means of a technique chosen from hydroentanglement, glueing and hot-melt bonding.

30. The method according to claim 28, characterized in that a second series of yarns (10f, 10f1, 10f2) is placed between the first and second outer layers (10a, 10b), the yarns of each of the first (10e) and second (10f, 10f1, 10f2) series being substantially parallel to one another and forming an angle α with the yarns of the other series.

31. The method according to claim 30, characterized in that the yarns of the first series (10e) are deposited after and on top of the yarns of the second series (10f).

32. The method according to claim 30, characterized in that the yarns of the second series (10f1, 10f2) are deposited so as to form, with the yarns of the first series (10e), a structure similar to a textile screen, the yarns of the first series (10e) forming the warp yarns and the yarns of the second series (10f1, 10f2) forming the weft yarns.

33. The method according to claim 32, characterized in that the angle α is approximately equal to 90°.

34. The method according to claim 31, characterized in that the laps of fibres (10a, 10b) primarily comprise hydrophilic cotton fibres.

35. The method according to claim 31, characterized in that the laps of fibres (10a, 10b) comprise from 70 to 100% of cotton fibres and from 0 to 30% of artificial fibres, chosen from the group consisting of viscose fibres, polyester fibres, polyester/polyester two component fibres, polypropylene/polypropylene two component fibres or polyester/polypropylene two component fibres, or mixtures thereof.

36. The method according to claim 30, characterized in that the yarns (10c, 10d, 10e, 10f) are manufactured from a material chosen from polymers of natural, artificial or synthetic origin, metallic materials and mineral materials.

37. The method according to claim 30, characterized in that the yarns (10c, 10d, 10e, 10f) are formed according to a method chosen from spinning, extrusion and moulding.

38. A skin care pad (1), such as a makeup remover pad based on hydrophilic cotton fibres, adapted to apply and/or remove liquid or semi-solid substances to/from the skin, comprising at least a first outer layer made of an absorbent fibrous material and at least a second outer layer and further comprising a series of yarns between the outer layers, said yarns forming a raised pattern at the surface of the article.
